(19) United States
(12) Patent Application Publication
(10) Pub. No.: US 2002/0036275 A1
(43) Pub. Date: Mar. 28, 2002

(54) Position detection device and position detection method

(76) Inventor: Yasuhiro Fukuzaki, Saitama (JP)

Correspondence Address: WELLS ST. JOHN P.S., 601 W. FIRST, SUITE 1300, SPOKANE, WA, 99201-3828, US

(21) Appl. No.: 09/965,021

(22) Filed: Sep. 26, 2001

(30) Foreign Application Priority Data
Sep. 28, 2000 (JP) 2000-295488

(51) Int. Cl. G01N 21/86; G01V 8/00

(52) U.S. Cl. 250/559.29

(57) ABSTRACT

The position detection device disclosed has a light source unit provided at a tip portion of a position pointing device, and an optical unit for detecting an incident direction of light from a position pointing device. The optical unit has an optical lens, a group of light detection elements, a group of first signal holding elements, a group of second signal holding elements, a group of connection switching elements, a differential output element, and a signal selecting element. The light source unit has a light source element, and a synchronizing element. The position detection device according to the present invention can eliminate extraneous light by high speed modulation, and provide a low cost optical digitizer which is resistant to disturbance noise.

### RELATED APPLICATIONS

This application relates to and claims a priority from Japanese Patent Application No. 2000-295488 filed on Sep. 28, 2000.

### BACKGROUND OF THE INVENTION

1 Field Of The Invention

The present invention relates to an optical digitizer and more particularly to an optical digitizer in which any influence from extraneous light is reduced.

2 Description Of The Related Art

A position detection device with which a position of a position pointing device is obtained based on the triangular principle has been known. In such a device, at least two optical units are provided in the peripheral region of the position detection area and, at these different positions, the incident angles of the light or shadow are detected. The light receiving elements for the detection of incident angles of the light or shadow may be roughly classified by their configurations into the following two methods. For example, in one method, a polygon mirror may be rotated and, by scanning the paths of light in beam form, the light detection is carried out by a single light receiving element. In the other method, by using a so-called linear image sensor in which a plurality of light receiving elements are one-dimensionally arranged thus enabling to obtain at once a view field angle in a folding fan shape.

In the method in which a linear image sensor is used, theoretically it is possible to eliminate a movable part, so that the merit is that the device can be compact and low cost. Now available linear image sensors (one dimensional CCD) are not limited to one that allows only a sequential read out. Since linear image sensor can now be configured using CMOS and outputs of respective light receiving elements can be read out randomly, the position detection device of the above kind now opens to higher freedom of designing.

On the other hand, an example of system in which, by using a single element light receiving element, a light beam is rotated is disclosed in publications including Japanese Patent Application Kokai Publication No. Hei 11-85377. In such a system, since the light receiving element is single so that the high speed reading out of signals is possible and, by conducting the sampling synchronously with the modulation of the light source, any influence of peripheral light can be widely reduced. For example, the light source provided to the position pointing device may be flashed on and off at a predetermined frequency which is sufficiently faster than the scanning rate and, when the signals from the light receiving element are synchronously detected and only the signals of the same frequency are taken out, it is possible to remarkably reduce the usual influence of surrounding light. An example in which, although not a single element, but a PSD (Position Sensing Device) of two elements are used to reduce the influence of the surrounding light by the modulation of light, is found in Japanese Patent Application Kokai Publication No. Hei 11-85378.

The linear image sensor is provided with a plurality of elements so that the reading out of the outputs thereof sequentially takes time, and it was not possible to realize the system which can perform the modulation by a frequency higher than the scanning rate. Also, because a large number of a plurality of light receiving elements are arranged, a light receiving area of respective light receiving elements is small so that, in order to obtain the sensitivity comparable to that of a single element light receiving element, it was necessary to conduct time integration. For this reason, even where the sequential reading is with a CMOS type linear image sensor which is randomly selectable, it was still unable to conduct modulation at high speed frequencies.

### SUMMARY OF THE INVENTION

In order to solve the problems mentioned above, the present invention is to provide a position detection device comprising a position pointing device for emitting light, reflecting light or intercepting light; a position detection area for defining an operable area of the position pointing device; one or a plurality of light source units provided either at a tip portion of the position pointing device or a periphery of the position detection area; an optical unit for detecting an incident direction of light or shadow from the position pointing device disposed at least two positions of the periphery of the position detection area; and an arithmetic processing unit for calculating a pointing position of the position pointing device based on outputs from the optical unit, the optical unit having: an optical lens, a group of light detection elements provided linearly with a plurality of light receiving elements, a group of first signal holding elements for holding at predetermined timing, detection signals of respective light receiving elements of the group of the light detection elements, a group of second signal holding elements for holding, at the other predetermined timing, detection signals of respective light receiving elements of the group of the light detection elements, a group of connection switching elements for selectively connecting the outputs of the light detection element group either to the first signal holding element group or the second signal holding element group, a differential output element for taking out a difference between output signals of the first signal holding element group and output signals of the second signal holding element group, and a signal selecting element for selectively obtaining the signals of the difference between the first signal holding element group and the second signal holding element group in the form corresponding to the respective elements of the light detection element groups, the light source unit having: a light source unit, and a synchronizing element for synchronizing a light emitting timing of the light source element with a connection switching timing of the connection switching element group.

The arithmetic processing unit mentioned above contains an A/D converter for converting an analog signal from the differential output element of the optical unit to digital information, and a digital processing circuit for conducting an arithmetic processing based on the output value of the A/D converter.

Alternatively, the connection switching group of the optical unit may sequentially perform connection switching at a predetermined timing in a sequence corresponding to the sequence in which the light receiving elements are lined up. The arithmetic processing unit contains a comparator element for binalizing an output level of the differential output element at a predetermined reference level, a reference level setting element for setting the reference level of the comparator element, and a time detection circuit for detecting a timing of an output change of the comparator element, whereby angle information of the light or shadow from the position pointing device is outputted as time information.

A position detection method according to the present invention which is carried out by a position detection device having a position pointing device for emitting light, reflecting light or intercepting light; a position detection area for defining an operable area of the position pointing device; one or a plurality of light source units provided either at a tip portion of the position pointing device or a periphery of the position detection area and repeatedly lighting on and lighting off at a predetermined cycle; an optical unit having a group of light detection elements provided linearly with a plurality of light receiving elements and for detecting an incident direction of light or shadow from the position pointing device disposed at two positions of the periphery of the position detection area; and an arithmetic processing unit for calculating a pointing position of the position pointing device based on outputs from the optical unit, has a received light signal holding step for holding detection signals of the light receiving element of the optical unit respectively at light-on and light-off of the light source unit, a differential output obtaining step for taking out differences between the lighting-on signals and the lighting-off signals corresponding to the signals held at the received light signal holding step, and an arithmetic processing step for calculating the pointing position of the position pointing device based on signals obtained at the differential output obtaining step.

The arithmetic processing step is one in which a digital calculation is performed based on a digital signal which is digitalized from an analog signal in the differential output obtaining step.

The sequence of taking out the differences in the differential output obtaining step follows a sequence in which the light receiving elements are lined up and, in the processing in the arithmetic processing step, an output level obtained during the differential output obtaining step is binalized at a predetermined reference level by a comparator element, and a timing of a change in an output of the comparator element is detected by the time detection circuit, whereby the angle information from the position pointing device is outputted as time information.

Also, instead of the analog memories and the differential amplifier, inverters and integration circuits may be utilized. In such a case, the circuit which inverts the signal is placed preceding the integration circuit and, while the polarity of the input signal is being inverted, the integration is carried out each time for the same time length. In this way, the merit is that, even when there is strong steady-state extraneous light, if the integration frequency is increased while the inversion frequency is raised, even feeble signal light can be detected.

### BRIEF DESCRIPTION OF THE DRAWINGS

The above and other objects, features and advantages of the present invention will be apparent from the following description of preferred embodiments of the invention explained with reference to the accompanying drawings, in which:

FIG. 1 is a block diagram showing an embodiment of the invention in which analog memories, and an A/D converter are used;

FIG. 2 is a block diagram showing an embodiment of the invention in which analog memories, a comparator, and a timing counter are used;

FIG. 3 is a block diagram showing an embodiment of the invention in which integration holding elements and an A/D converter are used;

FIG. 4 is a block diagram showing an embodiment of the invention in which integration holding elements, a comparator, and a timing counter are used;

FIG. 5 is a circuit diagram showing one example of a configuration of an inverter circuit;

FIG. 6 is a timing chart showing operation of two switches of the inverter circuit;

FIG. 7 is a circuit diagram showing another example of a configuration of an inverter circuit;

FIG. 8 is a conceptual diagram of the entire position detection device according to the invention;

FIG. 9 is a diagram showing a manner of calculating the position coordinate of the position pointing device based on the triangular principle; and

FIG. 10 is a circuit diagram showing an embodiment in which inverter circuits and integration circuits are used instead of the analog memories and the differential amplifier.

### PREFERRED EMBODIMENTS OF THE INVENTION

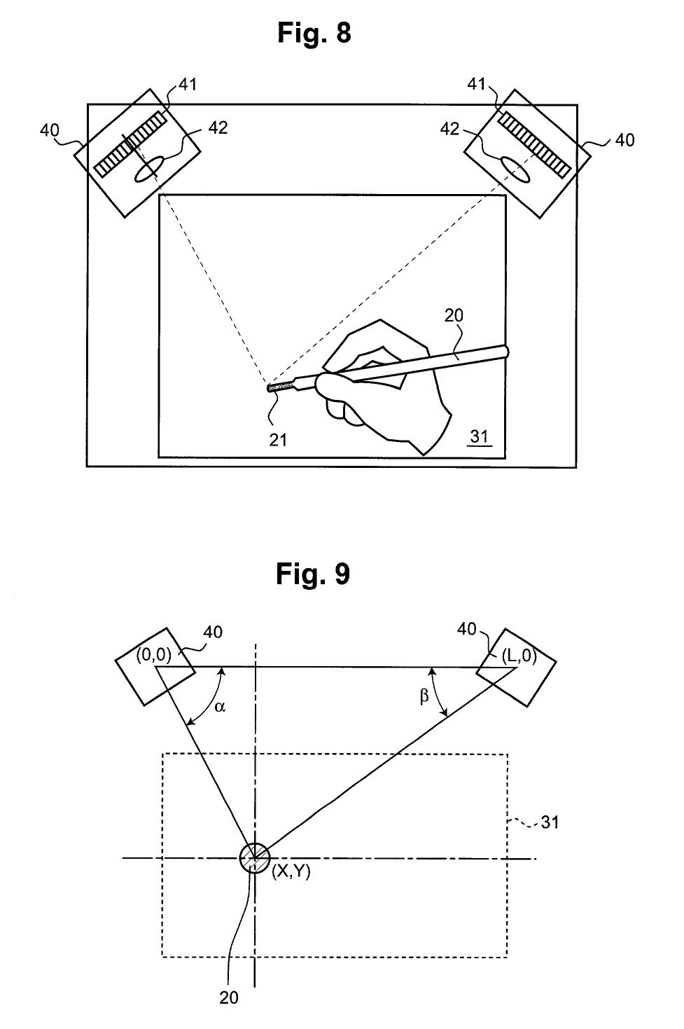

Now, preferred embodiments of the invention are explained with reference to the drawings. FIG. 8 is a conceptual diagram showing the overall views of the position detection device according to the invention. Here the position pointing device 20 is shaped similar to a writing instrument and is adapted to be held in a hand of the operator. The pen tip 21 is provided with a retroreflective material which returns the received light substantially in the same direction as it is received. The position detection region 31 is constituted by a substantially flat plate and, when the operator operates the position pointing device 20 to perform the position pointing (coordinate input to a host computer), the pen tip 21 moves on and along the position detection region 31. In the periphery of the position detection region 31, there are at least two optical units 40. In the related embodiment, when the position detection region 31 is formed in a rectangular shape, each optical unit 40 is located near each of the angles with the angles that allow each optical unit 40 to command the entire view of the position detection region 31. The optical unit 40 has a light receiving section 41 and an optical lens 42, and the light which returns from the pen tip 21 is conducted to the light receiving section 41 through the optical lens 42. Illustration has been omitted, but an example may be explained in which the light emitting sections 60 constituted by light emitting diodes may be provided respectively in the vicinity of the optical units 40 and the light may be emitted so as to cover the position detection region 31.

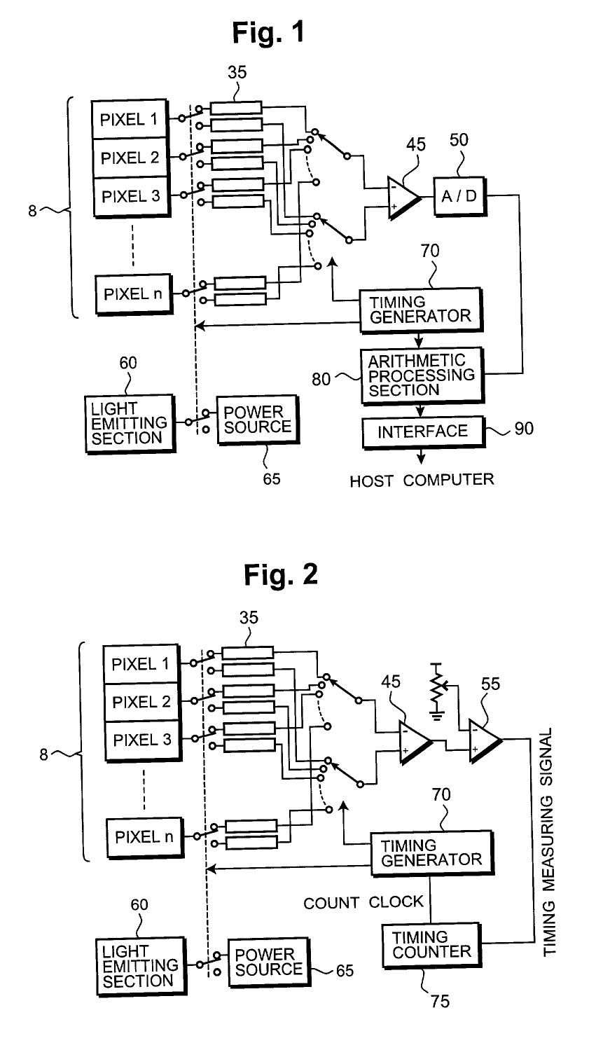

FIG. 1 is a block diagram showing an embodiment of the invention in which analog memories and an A/D converter are used. In FIG. 1, the illustration of the position detection region 31 and the position pointing device 20 is omitted. A light receiving element array 8 is a group of light receiving elements having a plurality of pixels (pixel 1 to pixel n) and is the group of light receiving elements which, among the portions constituting the light receiving section 41 in FIG. 8, receive first the light from the position pointing device 20. The outputs respectively of the light receiving elements of the array 8 are switched and held respectively at two analog memories 35. The switching timing is provided by a timing generator 70 and, at the same timing, a power source 65 of the light emitting element to the light emitting section 60 is switched on. That is, the output of the switched-on state and that of the switched-off state are held by respectively different elements. The signals of the analog memories 35 are further inputted to a differential amplifier 45, through the analog switch, where the difference of the intensity of the light received by the respective pixels as between one under the switched-on state and the switched-off state is obtained. The output of the differential amplifier 45 is digitalized by the A/D converter 50 and is transmitted to an arithmetic processing section 80. At the arithmetic processing section 80, the coordinate of the position pointing device 20 at the position detection region 31 is calculated (a detailed method of calculation is explained later with reference to FIG. 9), and is transmitted to a host means (for example, a personal computer) though an interface 90.

In the configuration of FIG. 1, parts up to the light receiving element array 8, the analog memories 35 and the differential amplifier 45, together with the two switch groups, may preferably be designed as one customized integrated circuit. Also, although, for finally obtaining the pointed position of the position pointing device, similarly the two sets of the parts up to the light receiving element array 8, the analog memories 35 and the differential amplifier 45 are required, the other set has neither been illustrated nor explained for simplicity of the explanation. Also, it is possible to arrange that, instead of placing the switching circuit before the differential amplifier, such differential amplifier is provided to each of the pairs of the analog memories so as to allow the outputs thereof to be selectively switched. Also, the analog memory is so called sample holding circuit, so that it can be configured by a capacitor alone in its simplest form.

FIG. 2 is a block diagram showing an embodiment in which analog memories, a comparator and a timing counter are used. In this embodiment, unlike in the example shown in FIG. 1, an A/D converter is not used and aim thereof is to reduce the cost. The output values of the differential amplifier circuit 45 are inputted into the comparator 55. The prerequisite in this example is that the outputs from the pixels 1 to n of the light receiving array 8 are sequentially outputted, and inputted into the comparator 55. Comparison with an appropriate reference voltage is performed by the comparator 55 and, when the values of voltages become equal, this fact is transmitted to the timing counter 75. The timing counter may count the time until the signal from the comparator 55 is received. Since such time is in accordance with the position (strictly speaking, the angles α, β in FIG. 9) of the position pointing device 20 on the position detection region 31, it is possible to obtain the coordinate information of the position pointing device 20 based on the information from the two optical units. In this sense, the signal from the comparator 55 to the timing counter 75 can be called a timing measuring signal. In the present drawings, the illustration of an interface and a host means has been omitted, but the arrangement in which the coordinate information is outputted to the host computer through the interface is the same as in the embodiment shown in FIG. 1.

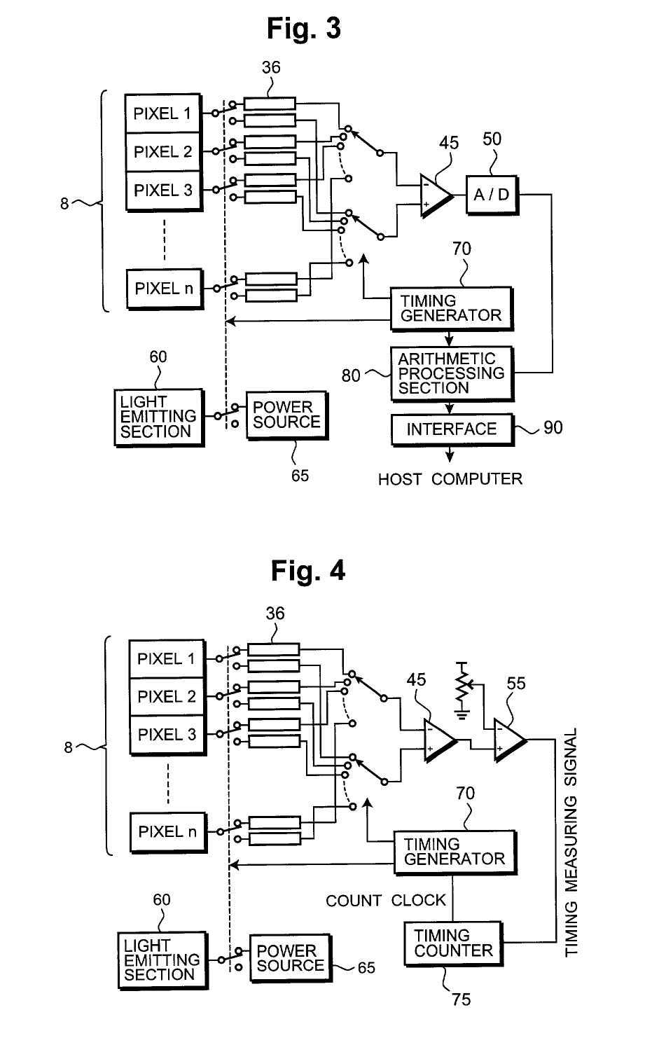

FIG. 3 is a block diagram showing an embodiment in which integration holding elements and an A/D converter are used. The difference from the embodiment shown in FIG. 1 is that instead of the analog memories, the integration holding element is used. When the integration holding element is used, and signal from the light receiving element is added several times (integrated), the signal which is feeble accordingly can be detected. The integration holding element, most simply, can be configured by a resistor and a capacitor.

FIG. 4 is a block diagram showing an embodiment in which integration holding elements, a comparator and a timing counter are used. Here the analog memory in FIG. 2 has been replaced by the integration holding element. In other respects the arrangements are the same as those in the embodiment of FIG. 2.

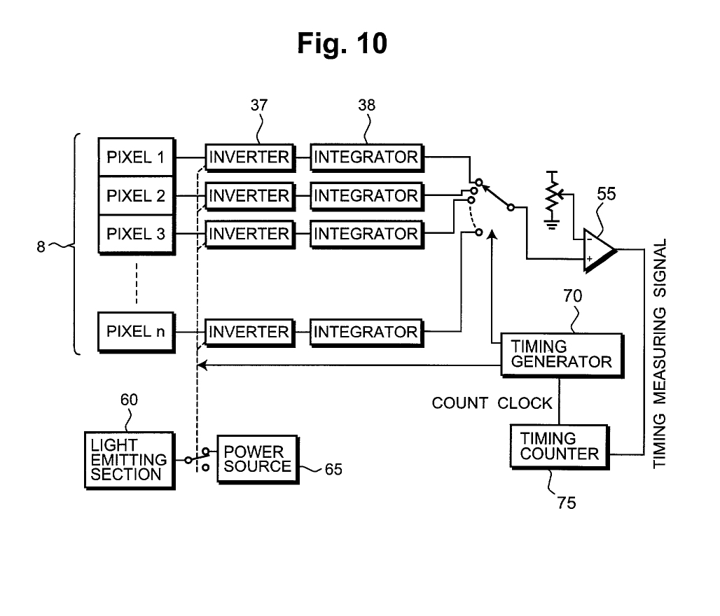

FIG. 10 is a circuit diagram of an embodiment in which, instead of the analog memories and the differential amplifier, inverters and integration circuits are used. This embodiment is in the form in which the differential amplifiers in FIGS. 2 and 4 are attained by the inverters and the integration circuits. Therefore, FIG. 10 does not include the illustration of the differential amplifier. For this embodiment, a circuit diagram in which the comparator 55 and the timing counter 75 corresponding to those in FIGS. 2 and 4 has been shown, but it is possible to similarly realize an embodiment in which an A/D converter and an arithmetic processing circuit are used.

Each of the inverters 37 shown in FIG. 10, as explained later, includes a switch, and the timing of the switching is provided by a timing generator 70, and the light emitting element 60 is provided with a light emitting power source 65 which supplies power for flashing of the light in synchronization. The arrangement is the same in other respects as the embodiments shown in FIGS. 2 and 4.

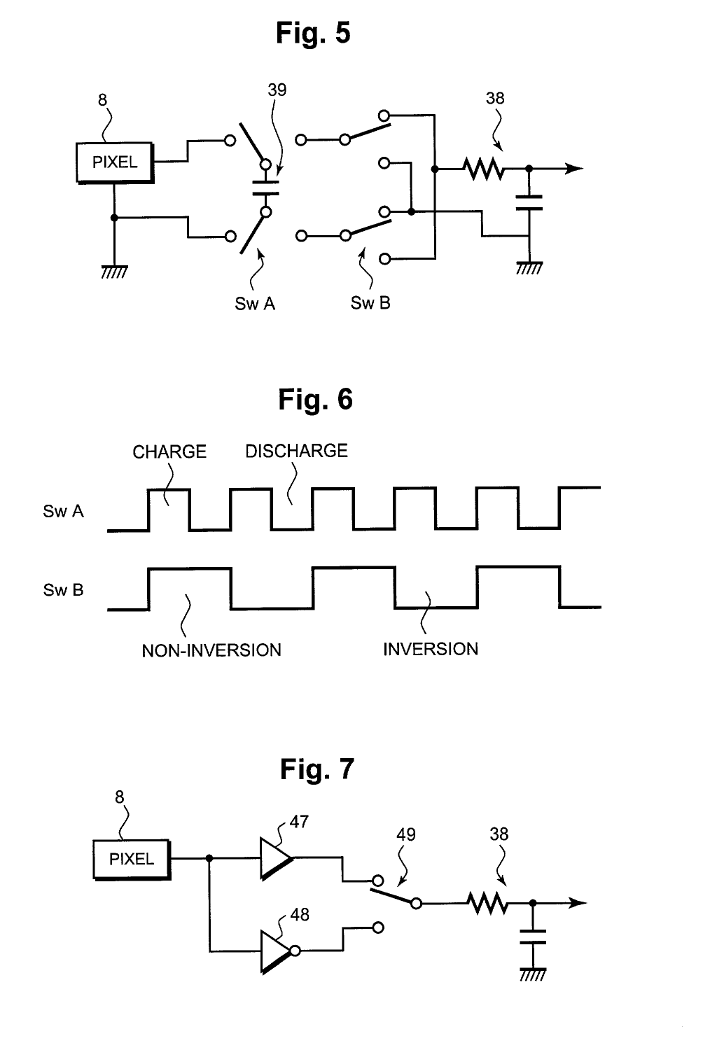

FIG. 5 is a circuit diagram showing details of the inverter 37 and the integration circuit 38 shown in FIG. 10. As shown in FIG. 5, the circuit can be configured by connecting a switch A, a switch B, a capacitor 39 and an integration circuit 38. The input signal is temporarily stored at the capacitor 39 and there is a circuit which inverts the connection to the output of the capacitor 39. FIG. 6 is the timing chart for showing the operations of the switch A and the switch B. As shown in FIG. 6, the switch A repeats the operation of the charge to and the discharge from the capacitor 39. The switch B is non-inverted and inverted in synchronization with the switching of the switch A. The switching cycle of the switch B is made, for example, two times the switching cycle of the switch A. The cycle of the switch B coincides with the flashing cycle of the light emitting element. In this way, the output values from the pixel can be taken out as the output values of the integration circuit 38 after the extraneous light (outside light) has been eliminated.

FIG. 7 is a circuit diagram showing another structural example of an inverter. As shown in FIG. 7, the output of the pixel may be connected both to a non-inverting amplifier 47 and an inverting amplifier 48 and, if these output values are switched and turned over to the integration circuit 38, it is possible to configure the inverting circuit. The switching of this switch 49 is made synchronous with the cycle of the flashing of the light emitting element 60.

The foregoing has explained with reference to the various embodiments an optical digitizer in which the light receiving element (optical unit) has in its vicinity the light emitting elements (light source units), and in which the position pointing device is a light reflecting type. The types of the optical digitizer include one in which the position pointing device emits light (one which has light source units as the position pointing device) or one in which the position pointing device intercepts light (one which has light source units at opposite side of the position detection region). The present invention can be applied to and embodied in the above types, too.

As to the types in which the position pointing device has light source units, if the position pointing device is connected by cables, it is simple to establish the synchronization between the light sources and the light receiving sections, but in order to attain “cordless” by eliminating the connection cables of the position pointing device, it becomes necessary to make arrangements for the synchronization with the switches concerned. For example, in the vicinity of the light receiving element, there may be provided a light receiving element for detecting the flashing timing of the light from the position pointing device (or one of the ordinary light receiving element arrays may do double functions) and, by using the timing detected, the timing of the changeover switch at the light receiving side can be synchronized.

In the device of the type in which the position pointing device intercepts the light, if the position detection region is rectangular, the light sources such as the photo diode arrays may be provided at the opposite sides, and the flashing timing of the light sources must be arranged so that the flashing timing synchronizes with the light receiving section side.

As above, the present invention can be applied to either arrangement whether the light source unit is located near the light receiving element side, or is provided at the position pointing device side, or is provided at the opposite side of the position detection region. Thus, in this specification, the portion from which the light is emitted is expressed broadly as a light source unit.

FIG. 9 shows a method with which the position coordinate of the position pointing device is calculated based on the triangular principle. The angles α and β of the position pointing device 20 detected by the light receiving sections 40 are calculated. If the distance between the two light receiving sections 40 is L, the following equations (1) and (2) hold.

Y=X·tan α (1)

Y=(L−X)·tan β (2)

wherein X, Y indicate the position coordinates of the position pointing device 20.

When X is found by using the above equations, the following equation (3) holds.

X=(L·tan β)/(tan α+tan β) (3)

If, by using these equations (1) and (3), the angles α and β can be detected, the position coordinates (X, Y) of the position pointing device 20 at the position detection surface 31 can be calculated.

The foregoing has shown a method by which the angle information at the time when the position pointing device is seen from the respective optical units 40 is converted to the XY coordinate system. Normally, it is often arranged that an arithmetic unit is provided within the position detection device and the coordinate conversion is carried out there. However, it is also possible to arrange that such a simple coordinate conversion as above may be disposed of by the processing within a host computer connected to the position detection device. Especially since most of recent personal computers enable high speed floating-point calculation, such computers may be advantageously utilized to simplify the process. Among the components of the device according to the invention, especially an arithmetic processing unit is not provided within the device. Where angle information is taken out through timing information, the information can be taken out only through hardware, so that the coordinate calculation process may be left to such a host computer to assist the cost performance. In the explanation of the embodiments, especially the embodiments shown in FIGS. 2 and 4, the arithmetic processing unit which processes the coordinate conversion has not been explained in detail as a part of the position detection device.

In the embodiments shown in FIG. 1 through FIG. 4, the signal selected at the signal selecting circuit is connected to one differential output element (differential output amplifier 45), but it is possible to arrange that a plurality of differential output elements are provided to respective light receiving elements and one output is selected from the plurality of outputs.

In the optical digitizer using a linear image sensor, it has been made possible to eliminate extraneous light by high speed modulation.

The invention enables providing a low cost optical digitizer which is resistant to disturbance noise.

While the invention has been described in its preferred embodiments, it is to be understood that the words which have been used are words of description rather than limitation and that changes within the purview of the appended claims may be made without departing from the true scope of the invention as defined by the claims.

What is claimed is:

1. A position detection device having a position pointing device for emitting light, reflecting light or intercepting light; a position detection area for defining an operable area of said position pointing device; one or a plurality of light source units provided either at a tip portion of said position pointing device or a periphery of said position detection area; an optical unit for detecting an incident direction of light or shadow from said position pointing device disposed at two positions of the periphery of said position detection area; and an arithmetic processing unit for calculating a pointing position of said position pointing device based on outputs from said optical unit,
said optical unit having:
an optical lens,
a group of light detection elements provided linearly with a plurality of light receiving elements,
a group of first signal holding elements for holding, at predetermined timing, detection signals of respective light receiving elements of said group of said light detection elements,
a group of second signal holding elements for holding, at the other predetermined timing, detection signals of respective light receiving elements of said group of said light detection elements,
a group of connection switching elements for selectively connecting the outputs of the light detection element group either to the first signal holding element group or the second signal holding element group,
a differential output element for taking out a difference between output signals of said first signal holding element group and output signals of said second signal holding element group, and
a signal selecting element for selectively obtaining the signals of said difference between said first signal holding element group and said second signal holding element group in the form corresponding to the respective elements of said light detection element groups,
said light source unit having:
a light source element, and
a synchronizing element for synchronizing a light emitting timing of said light source element with a connection switching timing of the connection switching element group.

2. A position detection device according to claim 1, in which said arithmetic processing unit includes:
an A/D converter for converting an analog signal from said differential output element of said optical unit to digital information, and
a digital arithmetic circuit for conducting an arithmetic processing based on output values of said A/D converter.

3. A position detection device according to claim 1, in which said group of connection switching elements of said optical unit sequentially performs connection switching at a predetermined timing in a sequence corresponding to the sequence in which the light receiving elements are lined up,
said arithmetic processing unit including:
a comparator element for binalizing an output level of said differential output element at a predetermined reference level,
a reference level setting element for setting said reference level of said comparator element, and
a time detection circuit for detecting a timing of an output change of said comparator element,
whereby angle information of the light or shadow from said position pointing device is outputted as time information.

4. A method for detecting a position which is carried out by a position detection device having a position pointing device for emitting light, reflecting light or intercepting light; a position detection area for defining an operable area of said position pointing device; one or a plurality of light source units provided either at a tip portion of said position pointing device or a periphery of said position detection area and repeatedly lighting on and lighting off at a predetermined cycle; an optical unit having a group of light detection elements provided linearly with a plurality of light receiving elements and for detecting an incident direction of light or shadow from said position pointing device disposed at two positions of the periphery of said position detection area; and an arithmetic processing unit for calculating a pointing position of said position pointing device based on outputs from said optical unit, said method including:
a received light signal holding step for holding the detection signals of said light receiving element of the optical unit respectively at light-on and light-off of the light source unit,
a differential output obtaining step for taking out differences between the lighting-on signals and the lighting-off signals corresponding to the signals held at said received light signal holding step, and
an arithmetic processing step for calculating the pointing position of said position pointing device based on signals obtained at said differential output obtaining step.

5. A position detection method according to claim 4, in which, in said arithmetic processing step, a digital calculation is performed based on a digital signal which is digitalized from an analog signal in said differential output obtaining step.

6. A position detection method according to claim 4, in which, in said differential output obtaining step, a sequence of taking out the differences follows a sequence in which said light receiving elements are lined up, and
in said arithmetic processing step, an output level obtained during said differential output obtaining step is binalized by a comparator element at a predetermined reference level, a timing of a change in an output of said comparator element is detected by a timing detection circuit, and the angle information from the position pointing device is outputted as time information.

7. A position detection device having a position pointing device for emitting light, reflecting light or intercepting light; a position detection area for defining an operable area of said position pointing device; one or a plurality of light source units provided either at a tip portion of said position pointing device or a periphery of said position detection area; an optical unit for detecting an incident direction of light or shadow from said position pointing device disposed at two positions of the periphery of said position detection area; and an arithmetic processing unit for calculating a pointing position of said position pointing device based on outputs from said optical unit,
said optical unit having:
an optical lens,
a group of light detection elements provided linearly with a plurality of light receiving elements,
a group of inverter circuits for inverting, at a predetermined timing, detection signals of the respective light receiving elements of the light detection element group,
a group of integration circuit for integrating outputs of the inverter circuit group, and
an output selecting and switching element for selecting predetermined outputs from the integration circuit group,
said light source units including:
a light source element, and
a synchronizing element for synchronizing a light emitting timing of said light source with an inverting timing of said group of said inverter circuits.

8. A position detection device according to claim 7, in which said arithmetic processing unit includes:
an A/D converter for converting analog signals from said integration circuit group of said optical unit to digital information, and
a digital arithmetic processing circuit for conducting digital calculation based on output values of said A/D converter.

9. A position detection device according to claim 7, in which said output selecting and switching element of said optical unit sequentially performs connection switching at a predetermined timing in a sequence corresponding to the sequence in which the light receiving elements are lined up,
said arithmetic processing unit including:
a comparator element for binalizing the output level of the integration circuit group at a predetermined reference level,
a reference level setting element for setting the reference level of said comparator element, and
a time detection circuit for detecting a timing of an output change of said comparator element,
whereby angle information of the light or shadow from said position pointing device is outputted as time information.

10. A position detection device according to claim 7, in which each of said inverter circuits is configured such that an input signal is connected to both a non-inverting amplifier and an inverting amplifier, and outputs thereof are switchable.

11. A position detection device according to claim 7, in which each of said inverter circuits comprises a capacitor which temporarily stores an input signal, and a circuit which inverts an connection to an output of said capacitor.
